(19) United States
(12) Patent Application Publication
(10) Pub. No.: US 2008/0189381 A1
(43) Pub. Date: Aug. 7, 2008

(54) METHOD AND SYSTEM FOR SECURE COMMUNICATION BETWEEN DEVICES

(75) Inventor: Jean-Francois POIRIER, Deux-Montagnes (CA)

Correspondence Address: BERESKIN AND PARR, 40 KING STREET WEST, BOX 401, TORONTO, ON, M5H 3Y2, omitted

(73) Assignee: UNIVERSAL DATA PROTECTION CORPORATION, Markham (CA)

(21) Appl. No.: 12/023,460

(22) Filed: Jan. 31, 2008

Related U.S. Application Data
(60) Provisional application No. 60/887,694, filed on Feb. 1, 2007.

(51) Int. Cl. G06F 15/16

(52) U.S. Cl. 709/208

(57) ABSTRACT

The present invention relates to a closed system having multiple electronic devices and to a method of communicating between electronic devices in a closed system. The method and system encode at least one output of a master device using an encoding code specific to the master device, transmit the encoded at least one output to a respective at least one slave device, and decode at each slave device the received encoded output of the master device using a decoding code that is symmetrical to the encoding code. More particularly, the system includes a master device and at least one slave device in communication with the master device. The master device comprises a master processor and an encoding module configured to encode at least one output of the master device using an encoding code specific to the master device. Each slave device comprises a slave processor and a decoding module configured to decode the output of the master device using a decoding code that is symmetrical to the encoding code.

### TECHNICAL FIELD

The embodiments described herein relate to a method and system for providing secure communication between electronic devices. In particular, the embodiments relate to methods and systems for providing secure communication between devices in a closed system or a closed network.

### BACKGROUND

In a closed electronic system, such as a home theatre system or a personal computer system, the components of the system exchange data in a manner independent of the other components of the system. For example, in a home theatre system comprised of a television and digital video disc (DVD) player, the DVD player sends the television unencrypted video and audio signals which the television amplifies and displays. Generally, the DVD player can be used with any television (with the necessary connectors) and the television can be used with any DVD player (with the necessary connectors).

As with other valuable equipment, such systems are susceptible to theft of the system or parts of the system, with the possible purpose of reselling the individual components.

Additionally, where components of such closed electronic systems perform decryption of data stored on a storage medium or another data source, such as media content on a compact disc (CD) or DVD, and the decrypted data are provided to another device in the system, such as a display or television, it is possible for the data thus provided to be copied in its unencrypted form.

It is desired to address or ameliorate one or more shortcomings or disadvantages associated with existing technologies for closed electronic systems and networks, or to at least provide a useful alternative thereto.

### SUMMARY

Some embodiments relate to a closed system having multiple electronic devices. The system comprises a master device comprising a master processor and an encoding module, the encoding module being configured to encode at least one output of the master device using an encoding code specific to the master device; at least one slave device in communication with the master device, each slave device comprising a slave processor and a decoding module, the decoding module being configured to decode the output of the master device using a decoding code that is symmetrical to the encoding code.

The at least one slave device may comprise a plurality of slave devices in communication with the master device and the decoding module of each slave device decodes the output of the master device using the respective decoding code of the slave device.

The master device may be configured to initialize the at least one slave device for encoded communication by transmitting a code setting command to the at least one slave device. The code setting may comprise the decoding code.

The master device may be configured to update the decoding code in each at least one slave device by transmitting an encoded update code command to each at least one slave device, the update code command being decodable using the decoding code and comprising a new decoding code, and wherein, in response to the update code command, the decoding module of each at least one slave device is configured to decode the output of the master device using the new decoding code. The slave processor of each at least one slave device may be configured to store the decoding code in response to the code setting command. The decoding code may be hard-coded in a decoding circuit in the slave device. The decoding code may be stored in a non-volatile memory of the slave device.

The closed system may comprise a closed network and wherein the master device and the at least one slave device communicate over a network bus. The encoding module may be configured to encode the at least one output in data blocks of a predetermined size using a first logic function and the decoding module of each at least one slave device is configured to decode the data blocks using a second logic function that is a logical inverse of the first logic function. The data blocks may be encoded and decoded on a block-by-block basis. The predetermined size may be a byte or a word.

The encoding module of the master device may comprise a first logic circuit configured to perform the first logic function and wherein the decoding module of each at least one slave device comprises a second logic circuit configured to perform the second logic function. The decoding module of each at least one slave device may be configured to decode only the output of the master device. The system comprises a plurality of master devices, wherein each slave device is in communication with at least one of the master devices.

Other embodiments relate to a method of communicating between electronic devices in a closed system. The method comprises: encoding at least one output of a master device using an encoding code specific to the master device; transmitting the encoded at least one output to a respective at least one slave device; and decoding at each slave device the received encoded output of the master device using a decoding code that is symmetrical to the encoding code. The method may further comprise initializing the at least one slave device for encoded communication with the master device by transmitting a code setting command to the at least one slave device. The code setting command may comprise the decoding code. The method may further comprise updating the decoding code in each at least one slave device by: transmitting an encoded update code command to each at least one slave device, the update code command being decodable using the decoding code and comprising a new decoding code; and decoding the respective output of the master device using the new decoding code in response to the update code command. The method may further comprise storing the decoding code in response to the code setting command.

The storing may comprise hard-coding the decoding code in a decoding circuit in the slave device. The storing may comprise storing the decoding code in a non-volatile memory of the slave device. The encoding may comprise encoding the at least one output in data blocks of a pre-determined size using a first logic function, and wherein the decoding comprises decoding the data blocks using a second logic function that is a logical inverse of the first logic function. The encoding and decoding may be performed on a block-by-block basis. The predetermined size may be a byte or a word. The decoding may comprise decoding only the respective output of the master device at the at least one slave device.

### BRIEF DESCRIPTION OF THE DRAWINGS

Embodiments of the invention are hereinafter described in further detail, by way of example only, with reference to the accompanying drawings, in which:

FIG. 1 is block diagram of an exemplary embodiment of a system for providing secure device communication;

FIG. 2 is a process flow diagram of a method of initializing the system shown in FIG. 1;

FIG. 3 is a process flow diagram of a method of sending and receiving messages in the system shown in FIG. 1;

FIG. 4 is a process flow diagram of a method of encrypting a message;

FIG. 5 is a process flow diagram of a method of decrypting a message;

FIG. 6 is a block diagram of a system for providing secure device communication according to another embodiment;

FIG. 7 is a process flow diagram of a method of initializing the system shown in FIG. 6;

FIG. 8 is a circuit diagram of an illustrative example of a hashing matrix;

FIG. 9 is an illustration of a linear feedback shift register (LFSR) for use in generating a variable key; and

FIG. 10 is an example hashing matrix combined with an XOR circuit.

### DETAILED DESCRIPTION OF THE EMBODIMENTS

The described embodiments relate to methods and systems that enable the linking of devices in a closed system or network such that they are only able to communicate with each other and no other devices. This would have the effect that if, for example, a television and DVD player are established as part of such a closed system, the television cannot be used with any other DVD player, thereby diminishing its usefulness and resale value and thwarting one possible purpose of the theft. This is a disincentive to prospective thieves of closed systems and networks (or components thereof) according to the described embodiments. The described embodiments may also be useful in protecting the decoded data output of one device to another to mitigate against copying of the decoded data.

The terms “encrypt” and “encode” and respective variations are used interchangeably in this description. Similarly, the terms “decrypt” and “decode” and their variations are also used interchangeably.

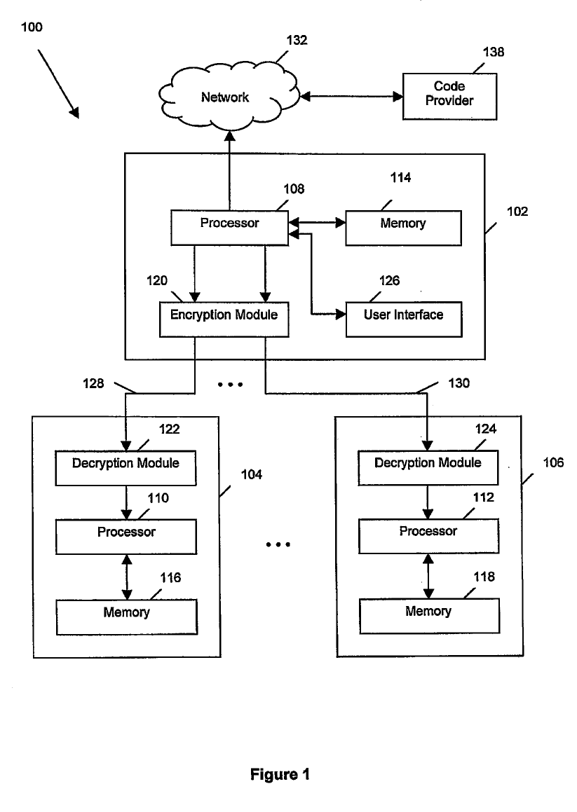

Referring now to the drawings, FIG. 1 is described in further detail. FIG. 1 is a block diagram of an exemplary embodiment of a system 100 for providing secure device-to-device communication. System 100 includes a master device 102, a first slave device 104, a second slave device 106 and a code provider 138 located remotely from the master and slave devices 102, 104 and 106. While system 100 shows one master device 102 and two slave devices 104 and 106, the number of master and slave devices in system 100 may be greater. Alternatively, only one slave device and one master device may be present.

The master device 102 and each of the slave devices 104 and 106 include respective data processors 108, 110 and 112 and respective memory units 114, 116 and 118. The data processors 108, 110 and 112 perform various data processing operations, including communicating with the other components in devices 102, 104 and 106, respectively. The data processors 108, 110 and 112 may comprise any suitable data processor having a speed and operating capacity to perform a series of logical operations in quick succession. For example, the data processors 108, 110 and 112 may have data throughput efficiency suitable for handling data quantities in the order of several megabytes in less than one second. One or more of the data processors in the slave devices may be or comprise an image processor.

The memory units 114, 116 and 118 may include flash memory or other read-only memory (ROM) and random access memory (RAM). The memory units 114, 116 and 118 may also comprise registers and cache blocks as necessary for efficient functioning. The memory units 114, 116 and 118 may be distinct from the data processors 108, 110 and 112. In one embodiment, each of memory units 114, 116 and 118 may be comprised in a separate removable memory device, such as a USB key, that can be inserted into the respective device 102, 104 and 106 or removed therefrom, for example to enable or to disable the encryption and decryption functions of the device 102, 104 and 106.

The memory units 114, 116 and 118 may have their contents encrypted (and decrypted) according to the methods and circuitry and/or components described in U.S. patent application Ser. No. 11/350,839, filed Feb. 10, 2006, the entire contents of which is hereby incorporated by reference.

The master device 102 further includes a user interface 126 and an encryption and decryption module 120. The user interface 126 is in communication with data processor 108, and is either part of the master device 102, or may comprise a separate interface device, such as a remote control unit. If master device 102 is a computer, such as a personal computer (PC), user interface 126 may comprise suitable user interface peripheral devices, including, for example, a keyboard, mouse, display screen or other peripheral, allowing a user to interface with the master device 102.

In some embodiments, master device 102 may comprise a CD reader, a DVD reader or other recordable media reader, as described in U.S. Utility patent application Ser. No. 11/470,779, filed Sep. 7, 2006, the entire contents of which are hereby incorporated by reference. In other embodiments, master device 102 may comprise a cable television receiver, satellite radio or television receiver or other subscription-based broadcast signal receiving device, as described in U.S. Utility patent application Ser. No. 11/559,164, filed Nov. 13, 2006, the entire contents of which are hereby incorporated by reference.

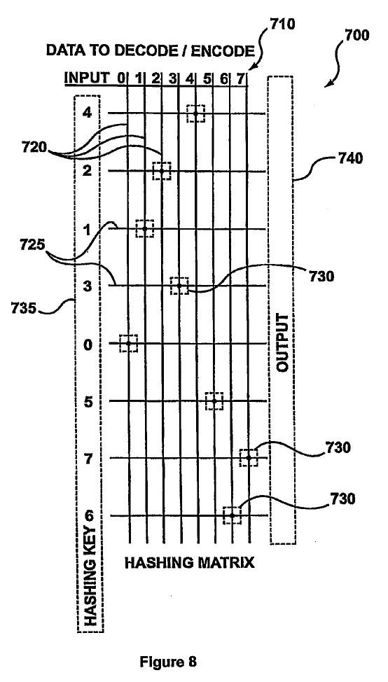

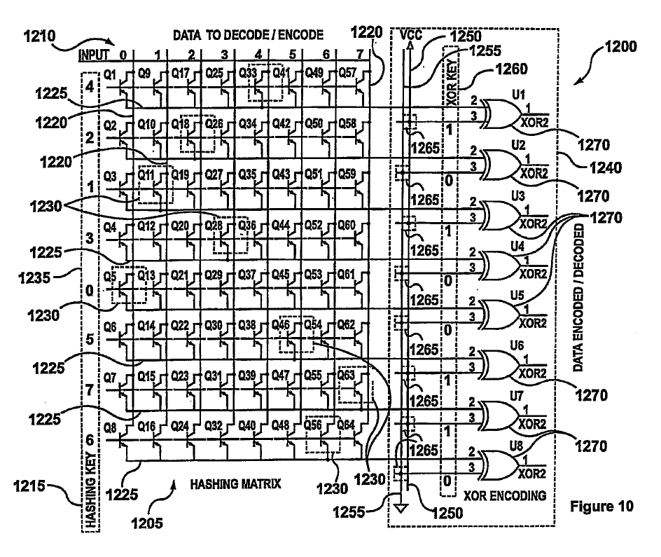

Slave devices 104 and 106 each comprise respective decryption modules 122 and 124 for receiving the encrypted data transmitted from encryption module 120 over communication links 128 and 130. Depending on the type of encryption performed by encryption module 120 in relation to the data to be transmitted to slave devices 104 and 106, decryption modules 122 and 124 may have greater or lesser circuitry and functional complexity. For example, where encryption module 120 transmits data to decryption module 122 over communication link 128 and the transmitted data is encoded in a byte-wise manner using a fixed key or combination of fixed keys, decryption module 122 may comprise hard-coded byte-wise transformation circuitry such as is shown in FIG. 8 or FIG. 10, for example, to decode each received byte.

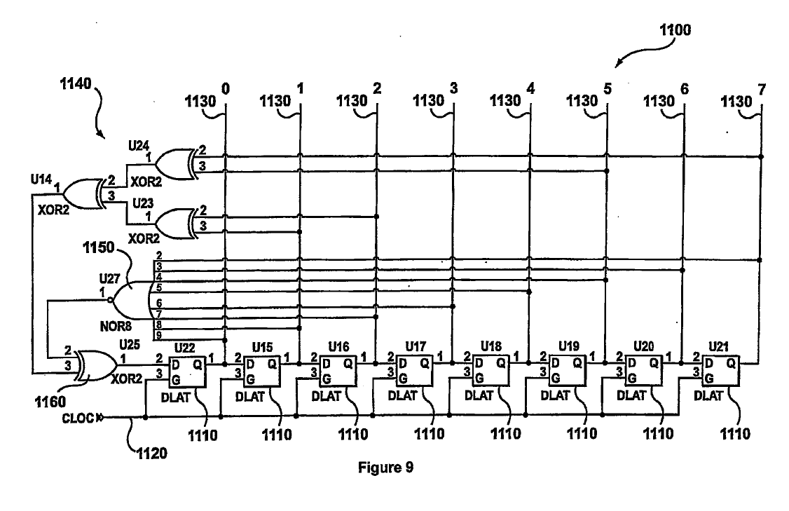

In another example, encryption module 120 may transmit data to decryption module 124 over communication link 130 using a variable key and a fixed key to encrypt the data. In such a case, decryption module 124 may comprise hard coded byte transformation circuitry, such as is illustrated in FIG. 8 or FIG. 10, for partial decoding, together with additional circuitry for generating the appropriate variable key to be used in completing the decryption. For example, where encryption module 120 uses a variable encryption circuit comprising a linear feedback shift register (LFSR) circuit, an example of which is shown in FIG. 9 and described below, to generate the variable key used in encoding the data, then decryption module 124 will comprise a similar variable key generation circuit to generate the appropriate variable key for use in decryption of the received data. Where such variable key encryption is used, it is necessary for decryption module 124 to synchronize its variable key generation with the incoming data so that the correct variable keys are generated. This may be accomplished by transmission of a synchronization signal from encryption module 120 to decryption module 124 prior to transmission of the variable key encrypted data.

While it is possible that the data transmitted by master device 102 to slave devices 104, 106 is the same for each slave device, the data on each communication link 128, 130 may alternatively be encrypted using separate encryption keys and separate encryption methods. For example, master device 102 may transmit data to slave device 104 that is encoded using a first fixed key and may transmit data to slave device 106 that is encoded using a second fixed key in combination with a variable key.

Once decryption modules 122, 124 receive and decrypt the incoming data from encryption module 120, the decrypted data is provided to the respective processor 110, 112 for processing according to the functions of slave devices 104, 106. Such device functions may be similar or entirely different from each other. For example, where master device 102 comprises a computer, slave device 104 may comprise a graphical display and slave device 106 may comprise a printer or data storage device. In another example, master device 102 may be a DVD player, slave device 104 may be a display, such as a television screen, and slave device 106 may comprise an amplifier or one or more digital speakers.

Code provider 138 may be in communication with data processor 108 over a network 132, such as the Internet, where the master device 102 is in connection with the network 132, either through a wired or wireless connection.

Code provider 138 is located remotely from the master device 102 and may comprise a computer system controlled by the manufacturer of the master and slave devices 102, 104 and 106.

Code provider 138 may allow fully automated data exchange with data processor 108. Alternatively, code provider 138 may accept encryption/decryption code requests through a form on a web page, an automated voice response (AVR) system or a call center operator, for example, and reply with the encryption/decryption code accordingly.

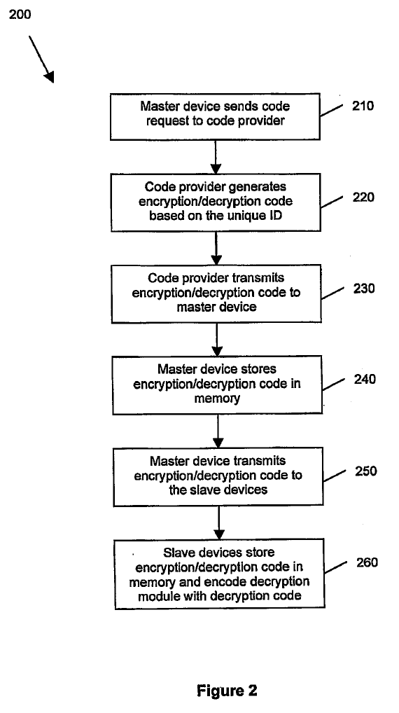

Referring now to FIG. 2, there is shown a process flow diagram of a method of initializing the system 100 shown in FIG. 1, the method being designated by reference numeral 200.

Method 200 begins at step 210, in which an initialization request is sent by the master device 102 to the code provider 138 over the network 132. The initialization request may comprise a unique identifier of the master device 102. In one embodiment, the initialization request may be automatically generated and sent by master device 102 to the code provider 138, where the master device 102 is connected to the network 132. In an alternative embodiment, the generation and transmission of the initialization request may be initiated manually by the user through the user interface 126.

If the initialization request does not include the unique identifier (10) of the master device 102, the code provider 138 may send a request over the network 132 to the master device 102 to provide its unique ID. In such a scenario, upon receipt of the unique ID request, processor 108 retrieves the unique ID stored in memory unit 114 and transmits the unique ID to the code provider 138 over the network 132.

In step 220, the code provider 138 generates a system encryption/decryption code based on the unique ID obtained in step 210. The unique ID obtained in step 210 may be used as a reference to a key database to allocate an encryption/decryption code to the master device 102. In step 230, the code provider 138 transmits the encryption/decryption code to the master device 102 over network 132. In step 240, master device 102 receives the encryption/decryption code and stores it in memory unit 114.

In step 250, master device 102 pushes the encryption/decryption code to the slave devices 104 and 106. For example, in the system 100 shown in FIG. 1, master device 102 transmits the encryption/decryption code to slave device 104 via communications channel 128 and to slave device 106 via communications channel 130.

In step 260, the encryption/decryption code is received by the slave device 104 and 106 at processors 110 and 112 and then saved in the corresponding memory unit 116 and 118. In an alternative embodiment, step 250 may be omitted and step 260 may be performed manually by a user, using a user interface associated with the slave device 104 or 106.

In an alternative embodiment of method 200, method steps 210 and 230 may be performed manually by the prospective consumer of the system 100 for each slave device, for example where the master device 102 is not connected to a network 132 or is otherwise unable to communicate directly and automatically with code provider 138. In a further alternative, master device 102 may generate the encryption and decryption codes itself, for example according to a random code selection circuit or module. This would obviate performance of steps 210 to 230.

If steps 210 and 230 are to be performed manually, master device 102 may guide the consumer to contact code provider 138, by telephone or on-line, for example, and provide the consumer with the unique ID to submit with the initialization request. The code provider 138 may then provide an encryption/decryption code to the consumer in the same way that it received the initialization request, so that the user can enter the encryption/decryption code into the master device 102 via user interface 126.

In an alternative embodiment of method 200, the code provider 138 obtains the unique ID of all devices in the system 100 in step 210 and the generated system encryption/decryption code is based on the unique IDs of all of the devices.

Once an encryption/decryption code is installed on a master or slave device, the device will encrypt all outgoing datablocks and/or messages using this code. Incoming data not encrypted with the correct encryption/decryption code will be processed as if they were encrypted but are likely to result in a nonsensical output.

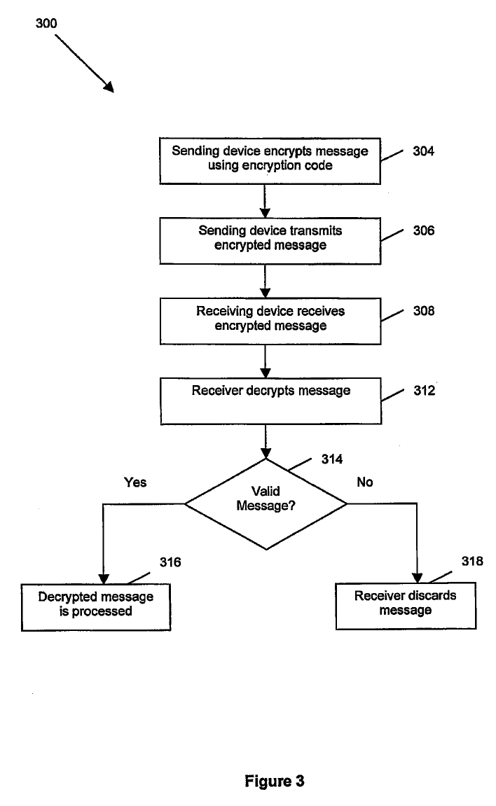

Referring now to FIG. 3, there is shown a flowchart of a method of transmitting data in the system 100 shown in FIG. 1, the method being designated by reference numeral 300. The data may be in the form of a continuous data stream of bytes, or may comprise consecutively transmitted data packets or data blocks.

Method 300 begins at step 304, at which the data processor 108 of the sending device 102 provides the unencrypted data to the encryption module 120 where the message is encrypted using the encryption code, as described in further detail below. If the encryption code is hard-wired into circuitry (e.g. 700 in FIG. 8 or 1200 in FIG. 10) within encryption module 120, then the encryption is at least partly performed by passing the data bytes through the relevant encryption circuitry. Alternatively, if the encryption is performed by software or programmable digital logic functions, the encryption module 120 loads the encryption code stored in memory 114 into a local register in order to use it to encode the outgoing data. At step 306, the data processor 108 of the sending device 102 transmits the encrypted message to the intended recipient over the communication channel 128.

At step 308 the decryption module 122 of the receiving device 104 receives the transmitted message. At step 312, decryption module 122 decrypts each incoming block of data using the decryption key previously written to slave device 104 by master device 102. If the decryption is performed by software or programmable digital logic functions, then, if necessary, the processor 110 of the receiving device 104 retrieves the decryption code from memory unit 116 for storage in a local register.

At step 314, the data processor 110 of the receiving device 104 checks whether the message is valid. If it is valid, then at step 316 the decrypted message is processed by the processor 110. For example, where the system 100 is a home theatre system and the master device is a receiver and the slave devices 104 and 106 are a television and speakers respectively, if the received message is valid the television will display the video image on the screen and the speakers will output the audio. If it is not valid, then at step 318 the message is discarded.

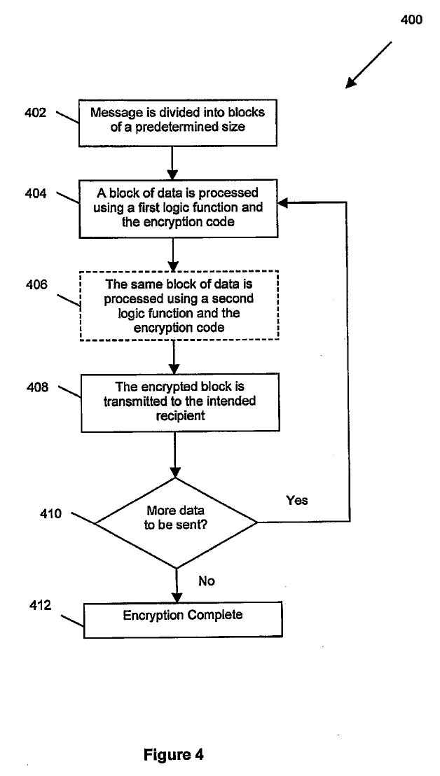

Referring now to FIG. 4, there is shown a process flow diagram of a method of encrypting a message, the method being designated generally by reference numeral 400. Method 400 begins with step 402 where the message is divided into blocks of a predetermined size and the first block of the message is read into a first buffer in memory 114. This size may be, for example, one byte or an integer multiple thereof. Alternatively, the block size may be a number of bits not divisible by 8.

At step 404, the quantity of data read into the first buffer at step 402 is processed using a first logic function and the encryption code that is hard-coded in the encryption circuitry or retrieved in method 300. Each data block is processed separately according to the first logic function and the processed blocks are sequentially stored in a second buffer in memory unit 114.

Each data block is then processed at step 406, using a second logic function and the encryption code to generate an encrypted block. The encrypted block is then transmitted, at step 408, to the intended recipient by data processor 114. At step 410, the data processor 114 checks whether there is any more data to be sent. If there is more data to be processed, steps 402 to 408 are repeated, otherwise, the encryption process is determined to be complete, at step 412.

The first and second logic functions used in steps 404 and 406, respectively, may be any suitable logic function for translating or transposing bits within the data block. Such suitable logic functions may include, but are not limited to, the exclusive-OR (XOR) function, a hash function, addition, subtraction, bit rotation or bit shifting. The first and second logic functions may be different or the same and may comprise combinations of functions.

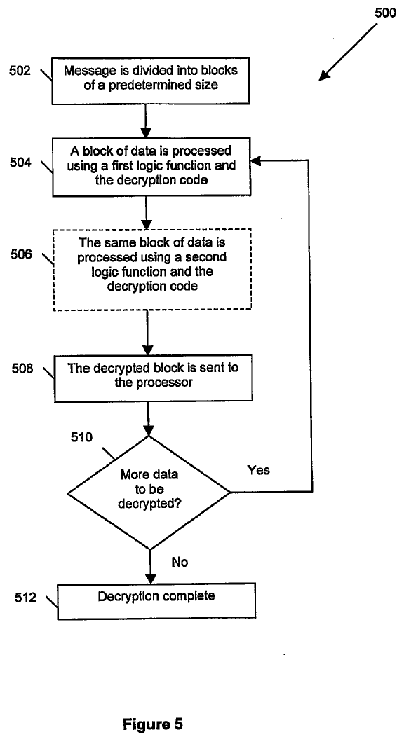

Referring now to FIG. 5, a method of decrypting a message is described in further detail and designated generally by reference numeral 500. Method 500 is essentially the inverse of method 400. Method 500 begins at step 502, at which the message to be decrypted is read into memory one block at a time. For example, if the data was encrypted on a byte-by-byte basis, the encrypted data blocks read at step 502 may be the size of a single byte. Alternatively, a multiple of the minimum block size may be read at step 502 so that a number of blocks are buffered together in the first buffer.

At step 504, the block of data read is processed using the inverse of the logic function used in step 404 of method 400 and the decryption code. The processed block is then stored in a second buffer in memory unit 116. At step 506 the data block stored in the second buffer in memory unit 116 is processed using the inverse of the logic function used in step 406 of method 400 and the decryption code. The logic functions used in steps 504 and 506 may be any suitable logic function for which an inverse of the function can be used in encryption. Examples of suitable logic functions are described in relation to method 400 above.

The decrypted block is transferred, at step 508, to the data processor 110 for processing. At step 510, the data processor 110 checks whether there is any more data to be decrypted. If there is more data to be decrypted, steps 502 to 508 are repeated, otherwise, the decryption process is determined to be complete, at step 512.

Referring now to FIG. 8, there is shown an example hashing matrix 700 for executing a hashing function, as part of the functions of the encryption module 120 or decryption module 122 or 124, as described above. The hashing matrix 700 comprises an array of conductors, with certain of the conductors being connected and all others being unconnected. The connected conductors are configured so as to correspond to a hashing key such that, for an example 8-bit input, each of those 8 bits can be mapped to a different bit position because of the position of each of the connected conductors within the array. These conductors can be connected by configuration fuses in a permanent configuration or can alternatively be electrically reconfigurable.

In the example shown in FIG. 8, an input byte having bit positions 01234567 is transposed by hashing matrix 700 into new bit positions 42130576 at the output.

The conductor connections can be formed in various ways, and may be configured so as to be one-time programmable (OTP) and not readable by magnetic polarization sensors. Thus, it is possible to form the conductor connections on a physical level, rather than being reconfigurable on a logic level.

Hashing matrix 700 comprises an input connection 710 on one side of the matrix and an output connection 740 on another side of the matrix. Input conductors 720 are oriented longitudinally, while output conductors 725 are oriented laterally to cross the input conductors. Each of the input conductors 720 and output conductors 725 are initially unconnected.

In a fixed key hard-coding procedure, in which selected connections 730 are made among the input connectors 720 and output connectors 725, connection points 730 are formed in hashing matrix 700. The configuration of connection points 730 is the fixed key in hard-coded form and the connection points 730 are formed according to the desired fixed (hashing) key 735 to be encoded in hashing matrix 700. All other locations in which input conductors 720 cross output conductors 725 remain insulated or otherwise unconnected so that each input conductor 720 is only connected to one output conductor 725 so as to ensure that the bit transposition between the input and output is one-to-one.

The hashing matrix shown in FIG. 8 can be used for encoding or decoding. If the hashing matrix is configured to encode outgoing bytes from encryption module 120, a corresponding inverse hashing matrix is also provided for the decoding process, for example as part of decryption module 122 or 124, in order to map the transposed bits back to their original positions. Alternatively, depending on the circuit configuration, the same hashing matrix can be used for the decoding, but in reverse manner.

While input conductors 720 and output conductors 725 are shown in FIG. 8 running perpendicularly, it should be understood that other conductor orientations and configurations can be employed where the conductors do not run perpendicularly, so long as they can be easily connected to each other at desired points to establish the desired hashing configuration. For example, input conductors 720 can run above and parallel to output conductors 725 but separated by a thin insulation layer whereby the insulation layer can be removed or turned conductive to connect the respective conductors as desired. It should also be understood that, instead of forming the connections of the hashing matrix by connecting selected conductors, the conductors can be pre-fabricated so that the input conductors are all connected to all of the output conductors and the fixed key is hard-coded by disconnecting all conductors except those between which connections are desired.

Connection points 730 are shown in FIG. 8 as being point connections. However, as shown in FIG. 10, conductor connections can instead be formed using other suitable connection means, such as transistors or other solid state devices.

Referring now to FIG. 9, there is shown an example of a LFSR circuit 1100. LFSR circuit 1100 comprises a plurality of D latches (flip-flops) 1110 connected in series and to a common clock 1120. Each of the D latches 1110 is connected to the previous D latch 1110 and to the next D latch 1110 in the series (unless it is first or last in the series). Each D latch 1110 has an output line 1130 connected to its output for outputting a voltage representative of a bit value of 1 or 0. The output lines 1130 of each D latch 1110 can also be used as feedback to a feedback logic circuit 1140, which forms part of the feedback input to the first D latch 1110 of the series.

In order to achieve the pseudo-random number generation along output lines 1130, only selected output lines 1130 are used as input to feedback circuit 1140. For example, as shown in FIG. 9, the second, third, sixth and eighth D latch output lines 1130 are used as input to feedback circuit 1140. The positions of the output lines 1130 selected for input to feedback circuit 1140 are also called tapping points. Depending on the selection of tapping points, the length of the pseudo-random number sequence (before it repeats) will vary, although there are some predetermined optimal tapping point configurations for providing a maximum pseudo-random number sequence length.

The example LFSR circuit 1110 shown in FIG. 9 has eight D latches 1110 (called an eight stage LFSR circuit) and four predetermined fixed tapping points. Depending on the desired LFSR circuit performance, different numbers of D latches 1110 can be used. Further, different numbers of tapping points and alternative tapping point configurations can be used, depending on the desired LFSR circuit performance. In one embodiment, the LFSR circuit can be configured to have variable tapping points, controllable by the microprocessor, to generate a different pseudo-random number sequence, depending on requirements.

It is necessary to provide a seed value to the LFSR circuit 1110 to begin the pseudo-random number generation sequence. This seed value can be input serially, beginning at the first D latch 1110 and propagating to the rest to the D latches 1110 over eight clock cycles. Alternatively, the D latches 1110 can be configured to allow parallel input of the seed bits in a single clock cycle.

For each clock cycle of clock 1120 the output of each D latch 1110 is provided to the subsequent D latch 1110 in the series and to an output line 1130. Thus, the bit values on each of the eight output lines 1130 depends on the output of the previous D latch 1110 from the previous clock cycle and on the feedback provided to the first D latch 1110 in the series.

In order to prevent the LFSR circuit 1110 from getting stuck on a series of zeros, the output of each D latch 1110 is also provided to a NOR gate 1150, the output of which is provided to XOR gate 1160, along with the output of feedback logic circuit 1140. The output of XOR gate 1160 is then provided as the feedback input to the first D latch 1110 of the series. Thus, if all output lines 1130 carry a 0 value, NOR gate 1150 will output a 1 value, which will allow the D latches to resume pseudo-random number generation.

Feedback logic circuit 1140 comprises, in this example of LFSR circuit 1100, three XOR gates. Two of the XOR gates each receive two of the four feedback inputs from the four tapping points and the outputs of these XOR gates are provided to the third XOR gate, which in turn provides its output to XOR gate 1160.

Referring now to FIG. 10, there is shown a particular embodiment of an encoding or decoding circuit, designated by reference numeral 1200, which may comprise at least part of the functions of encryption module 120 or decryption module 122 or 124. Circuit 1200 can also be used, in one possible embodiment, as at least part of variable key generation circuit, together with LFSR circuit 1110. Circuit 1200 comprises a hashing matrix 1205 in combination with an XOR encoding circuit 1240. The hashing matrix 1205 is similar in operation to hashing matrix 700 (and is shown encoding the same fixed key) in that it has a hashing key 1215 encoded or formed therein according to selected circuit connections formed between input conductors 1220 and output conductors 1225 of the hashing matrix 1205.

In contrast to circuit connections 730 of hashing matrix 700, hashing matrix 1205 uses a matrix of switching devices, such as transistors 1230, for example, which interconnect input conductors 1220 with output conductors 1225. The transistors can be bipolar junction transistors (BJTs) or field effect transistors (FETs), although the transistors illustrated in FIG. 9 are BJTs. Alternatively, other solid-state semiconductor devices or simple conductors can be used to form switchable or non-switchable connections between the input conductors 1220 and the output conductors 1225. In a further alternative, a form of multiplexer configured with a fixed or variable key can be used for transposing/redirecting the bits within each byte or word.

Depending on the fixed key code to be encoded or formed into hashing matrix 1205, certain of the transistors are selected for connecting each input line 1220 to a respective output line 1225. Unselected transistors in hashing matrix 1205 are either unconnected to the input and output conductors 1220, 1225 or are disabled by having their base terminals brought low. When the base terminal of each selected transistor 1230 is high, that transistor 1230 will be enabled, thus passing the input voltage on the relevant input conductor 1220 to the output conductor 1225 to which the respective transistor 1230 is connected, thereby transposing the bit positions of input 1210 to different output bit positions. In an embodiment of hashing matrix 1205 that is reconfigurable, the base terminal of each transistor in the matrix is independently selectable, thereby allowing each input conductor 1220 to be selectively connectable to any output conductor 1225.

In the example circuit 1200 shown in FIG. 10, hashing matrix 1205 is employed in combination with an XOR encoding circuit 1240 connected to the output conductors 1225. Each of the output conductors 1225 is used as one input to an XOR gate 1270 in XOR encoding circuit 1240. The other input of each XOR gate 1270 provides one bit of an XOR key 1260 encoded into XOR encoding circuit 1240. XOR key 1260 is encoded by having the second input of each XOR gate 1270 connected to a selected one of a high input line 1250 or a low input line 1255, depending on the bit value of the XOR key 1260 to be encoded into each bit position of XOR encoding circuit 1240. For example, in order to provide a 1 to the second input of an XOR gate 1270, that input is connected, at connection 1265, to the high input line 1250. Conversely, in order to supply a 0 to the second input of an XOR gate 1270, that input should be connected at connection point 1265 to the low input line 1255. Connection points 1265 in XOR encoding circuit 1240 are preferably hard-wired and can be formed in a similar manner to connection points 730, described in relation to FIG. 8.

FIG. 10 shows XOR encoding circuit 1240 having a series of XOR encoding gates 1270 coupled to the output of the hashing matrix 1205. In the example embodiment illustrated, the XOR encoding circuit 1240 can be used to perform a further logic operation, either as part of the decoding or encoding process. Advantageously, in such an example embodiment, the XOR encoding gates 1270 can be used to perform the logic operation involving the fixed encryption or decryption key, while the hashing matrix 1205 can be used in the variable key encryption or decryption (if the hashing matrix is reconfigurable). In the example shown in FIG. 10, an input byte of value 11010111 would be transposed by hashing matrix 1205 into 00111111. The transposed byte would then be XORed with the (XOR key 1260) value 10100110 to provide an output byte of value 10011001.

While FIG. 10 shows an XOR encoding circuit 1240 in combination with hashing matrix 1205, it should be understood that either of these circuits can be substituted for alternative circuits, either having a hard-coded fixed key formed therein or generating a variable key, such as LFSR circuit 1100. However, at least one of the circuits should have a hard-coded fixed key formed therein. Circuit 1200 can be used for encoding or decoding data. If circuit 1200 is used for encoding data, a similar circuit is provided for decoding the data, except that hashing matrix 1205 will be inversely configured to transpose the bits in an inverse manner to the encoding circuit.

Alternative circuits can be used to perform the logic operations involved in the encryption/decryption, depending on the particular type of logic operation being performed. The transistors 1230 shown in FIG. 10 represent only one of a number of possible means to redirect a bit to a new position. For example, other forms of transistor or logic switch can be used instead of the transistor switches 1230 shown in FIG. 10 and other logic switch configurations can be used for logic operations other than hashing.

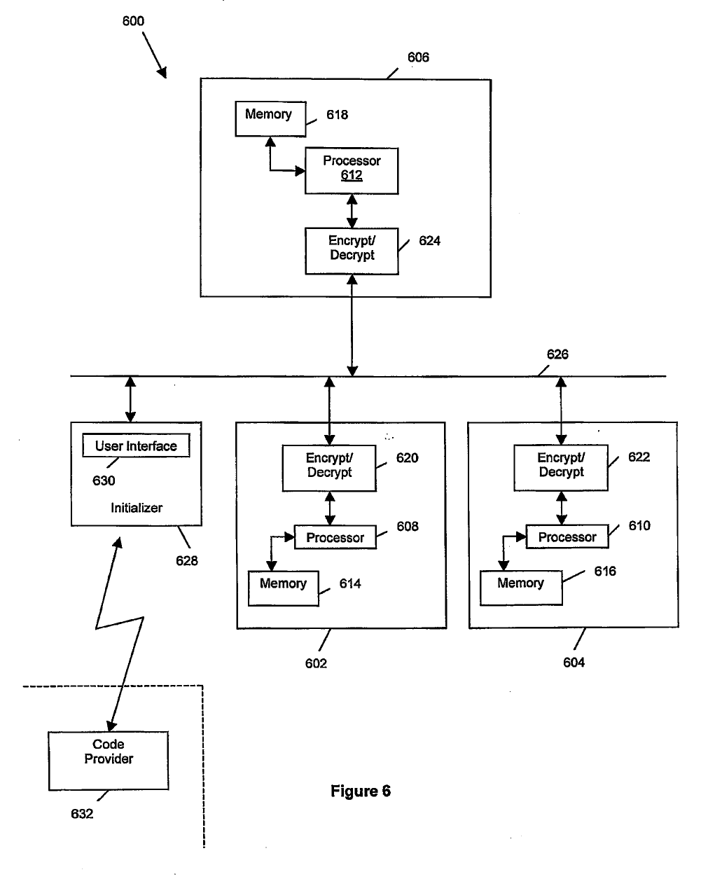

Referring now to FIG. 6, there is shown a block diagram of a system 600 for providing secure device-to-device communication according to another embodiment. System 600 differs from system 100 in that system 600 is a closed network where there is bi-directional communication between the devices over a common network, whereas system 100 is a closed system where there is unidirectional communication from the master device to the slave devices over individual communication channels.

The example of system 600 shown in FIG. 6 includes three electronic devices 602, 604 and 606 connected to a common network 626 and an initializer 628 that is removably connected to the network 626. System 600 may alternatively comprise two or more than three devices communicating with each other in a manner similar to devices 602, 604 and 606, described below. System 600 further includes a code provider 632 that is situated in a location remote to the devices 602, 604 and 606. Each of the electronic devices 602, 604 and 606 have a processor 608, 610 and 612, a memory unit 614, 616 and 618, and an encryption/decryption module 620, 622 and 624. The requirements for and function of the processor, memory unit and encryption/decryption module have been described above in reference to system 100.

The three devices may exchange encrypted messages over the network 626. According to certain embodiments, to send a message, each data processor 608, 610 and 612 retrieves the encryption code from respective memory unit 614, 616 and 618. Each data processor 608, 610 and 612 then sends the message and the encryption code to its respective encryption/decryption module 620, 622 and 624, where the message is encrypted using the encryption code. Once the message is encrypted, it is sent to the desired recipient device over the network 626.

The process is the reverse when a device receives a message. The data processor 608, 610, and 612 retrieves the decryption code from the memory unit 614, 616 and 618. Both the decryption code and the encrypted message are sent to the encryption/decryption module 620, 622 and 624 where the message is decrypted.

The decrypted message is sent to the data processor 608, 610 and 612 and if the message is determined by the respective data processor to be valid, it is processed. If the message is determined not to be valid, then it is discarded. Validity of the message may be determined by checking an address in the message header, for example, and comparing it with an address of the device at which the message has been decoded. If the addresses match, then the message may be determined to be valid. Otherwise, the message may be considered to be invalid, at least insofar as the particular decoding device is concerned.

Network 626 may be configured as a bus, so that, when a device sends an encrypted message to another device, the message is put onto the bus and all devices receive the encrypted message. However, only the correctly addressed or correctly encrypted messages are readable by the correct receiving device. Other devices receiving an incorrectly addressed message, or a message encrypted in a manner that is not recognized, will not read the message and will discard it.

In one embodiment, devices 602, 604 and 606 may be comprised in an automobile control system. Devices in such a system may include, for example, an Electronic Control Module (ECM), a Global Positioning System (GPS) module, an Automatic Breaking System (ABS) module, a digital video disc (DVD) player and a satellite radio receiver system.

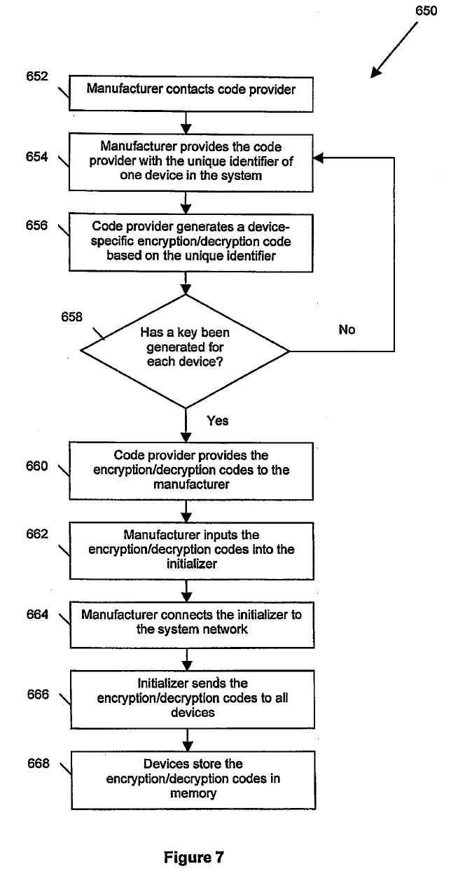

Referring now to FIG. 7, there is shown a process flow diagram of a method of initializing the system 600 shown in FIG. 6, the method being designated generally by reference numeral 650. The method begins at step 652, where the manufacturer of the system 600 contacts the code provider 632. At steps 654, 656 and 658, the manufacturer provides the unique identifier of each device one at a time and the code provider 632 generates a device-specific encryption/decryption code based on the unique ID provided.

At step 660 the code provider 632 provides the manufacturer with all of the device-specific encryption/decryption codes. At step 662, the manufacturer manually enters the encryption/decryption codes into the initializer 628 via user interface 630. At step 664, the manufacturer connects the initializer 628 to the network 626 and initiates distribution of the codes via user interface 630. At step 666, the initializer distributes all of the encryption/decryption codes to all of the devices 602, 604 and 606. At step 668, the devices 602, 604 and 606 store the codes in memory unit 614, 616 and 618. Additionally, step 668 may comprise hard-coding one or more encryption/decryption module 620, 622 and 624 and then erasing such keys from the respective memory 614, 616 and 618. In this way an encryption/decryption key specific to each device is stored in the device memory or circuitry within the encryption/decryption module, or both.

In an alternative embodiment of method 650, the code provider 632 does not generate one code per device in method step 656, but instead generates one system code based on the unique identifiers of all of the devices 602, 604 and 606 in the system 600, and this same system code is used by all devices in system 600, when communicating with each other.

In another alternative embodiment of method 650, method steps 652, 654, 660 and 662 are performed automatically, for example where initializer 628 is configured to communicate with code provider 632 over a network, such as the Internet, and where the initializer 628 is connected to the network, either through a wired or wireless connection.

In a further alternative embodiment of method 650, method step 666 is modified so that not all device-specific codes are sent to all devices 602, 604 and 606. The devices 602, 604 and 606 are only given the codes that they need to communicate. For example, in the automobile control system embodiment, that the GPS module and the ABS module do not need to communicate with each other, so the GPS module is not given the ABS module's code and similarly the ABS module is not given the GPS module's code. This adds a second level of security to the system.

An example of an alternative encryption and decryption method is described as follows. For processor 612 to properly decode data from network bus 626, it has to use a key C stored in 618. Suppose that the original data to be written to the bus 626 is some number 0xF0 (in hexadecimal). The original data is partially encrypted using a key A when it is written to the bus 626 by an external encryption/decryption module 620 or 622, so the data written to the bus may be 0x0F.

Encryption/decryption module 624 then decodes the data received from bus 626 with a key B, which may be 0x55, for example. Processor 612 then receives 0x55 XOR 0x0F, which equals 0x5A, (assuming that XOR is the chosen logic function for the encryption and decryption). Processor 612 then reads key C from memory location 618 use. If memory 618 has 0xAA as key C, processor 612 then processes 0x5A XOR 0xAA to get 0xF0, which is the original data. This encryption and decryption process relies on there being a relationship between keys A, B and C such that A XOR B=C. For logic functions other than the exclusive OR function, an equivalent reversible logical relationship is necessary.

A similar process is applied when device 606 sends data to device 602 via network bus 626. As in the above example, let us assume the data to be sent to device 602 is 0xF0. Processor 612 then encodes the data using key C stored in 618. Once encoded by processor 612, encrypt/decrypt module 624 encodes it again using its key B (0x55). The encoded data that will be sent on bus 626 will again be 0x0F. Encrypt/decrypt module 620 then decodes the data using its key A (0xAA). The data received by processor 608 will be 0xA5. Processor 608 then reads memory 614 to load its key C (0x55). Processor 608 then processes 0xA5 XOR 0x55=0xF0, which is the original data sent from device 606.

Although devices 602, 604 and 606 are shown in FIG. 6 as having a memory accessible only to the respective processor 608, 610 and 612, in an alternative embodiment, encryption/decryption module 620, 622 and 624 may also access the respective memory 614, 616 and 618 of each device in order to load an appropriate encryption or decryption key that is specific to another device from or to which the data is to be received or transmitted.

In this description, reference to an encryption code or a decryption code should be understood to include information to be used in the encryption or decryption process, specifically including an encryption or decryption key and, where appropriate, an encryption or decryption format identifier. The encryption or decryption format identifier specifies the type of logic operation to be used in encrypting or decrypting the data, together with an indication of whether variable key encryption or decryption is to be employed and, if so, one or more logic operations to be used in that encryption or decryption and the manner of generation of the variable key. If necessary, the encryption or decryption format identifier may specify a seed value or generation of the variable key, for example where a LFSR circuit is used to generate the variable key.

In certain embodiments, encryption/decryption modules 620, 622 and 624 may employ fixed and/or variable key encoding, as described previously, and may use the circuits shown and described in relation to FIGS. 8 to 10 for such purposes.

Although embodiments of the system shown in FIG. 6 may be applied to systems having multiple devices connected to each other through a network, as part of a larger device or system, still further embodiments may be applied to components of a single device within such a system 600. For example, devices 602, 604 and 606 may be components of a subsystem, among multiple such subsystems within the larger system 600.

While the above description provides examples of the embodiments, it will be appreciated that some features and/or functions of the described embodiments are susceptible to modification without departing from the spirit and principles of operation of the described embodiments. Accordingly, what has been described above is intended to be illustrative of the invention and non-limiting.

1. A closed system having multiple electronic devices, comprising:
a master device comprising a master processor and an encoding module, the encoding module being configured to encode at least one output of the master device using an encoding code specific to the master device;
at least one slave device in communication with the master device, each slave device comprising a slave processor and a decoding module, the decoding module being configured to decode the output of the master device using a decoding code that is symmetrical to the encoding code.

2. The system of claim 1, wherein the at least one slave device comprises a plurality of slave devices in communication with the master device and wherein the decoding module of each slave device decodes the output of the master device using the respective decoding code of the slave device.

3. The system of claim 1, wherein the master device is configured to initialize the at least one slave device for encoded communication by transmitting a code setting command to the at least one slave device.

4. The system of claim 3, wherein the code setting command comprises the decoding code.

5. The system of claim 4, wherein the master device is configured to update the decoding code in each at least one slave device by transmitting an encoded update code command to each at least one slave device, the update code command being decodable using the decoding code and comprising a new decoding code, and wherein, in response to the update code command, the decoding module of each at least one slave device is configured to decode the output of the master device using the new decoding code.

6. The system of claim 4, wherein the slave processor of each at least one slave device is configured to store the decoding code in response to the code setting command.

7. The system of claim 6, wherein the decoding code is hard-coded in a decoding circuit in the slave device.

8. The system of claim 6, wherein the decoding code is stored in a non-volatile memory of the slave device.

9. The system of claim 1, wherein the closed system comprises a closed network and wherein the master device and the at least one slave device communicate over a network bus.

10. The system of claim 1, wherein the encoding module is configured to encode the at least one output in data blocks of a predetermined size using a first logic function and the decoding module of each at least one slave device is configured to decode the data blocks using a second logic function that is a logical inverse of the first logic function.

11. The system of claim 10, wherein the data blocks are encoded and decoded on a block-by-block basis.

12. The system of claim 11, wherein the predetermined size is a byte or a word.

13. The system of claim 10, wherein the encoding module of the master device comprises a first logic circuit configured to perform the first logic function and wherein the decoding module of each at least one slave device comprises a second logic circuit configured to perform the second logic function.

14. The system of claim 1, wherein the decoding module of each at least one slave device is configured to decode only the output of the master device.

15. The system of claim 1, wherein the system comprises a plurality of master devices, wherein each slave device is in communication with at least one of the master devices.

16. A method of communicating between electronic devices in a closed system, comprising:
encoding at least one output of a master device using an encoding code specific to the master device;
transmitting the encoded at least one output to a respective at least one slave device; and
decoding at each slave device the received encoded output of the master device using a decoding code that is symmetrical to the encoding code.

17. The method of claim 16, further comprising initializing the at least one slave device for encoded communication with the master device by transmitting a code setting command to the at least one slave device.

18. The method of claim 17, wherein the code setting command comprises the decoding code.

19. The method of claim 18, further comprising updating the decoding code in each at least one slave device by:
transmitting an encoded update code command to each at least one slave device, the update code command being decodable using the decoding code and comprising a new decoding code; and
decoding the respective output of the master device using the new decoding code in response to the update code command.

20. The method of claim 18, further comprising storing the decoding code in response to the code setting command.

21. The method of claim 20, wherein the storing comprises hard-coding the decoding code in a decoding circuit in the slave device.

22. The method of claim 20, wherein the storing comprises storing the decoding code in a non-volatile memory of the slave device.

23. The method of claim 16, wherein the encoding comprises encoding the at least one output in data blocks of a pre-determined size using a first logic function, and wherein the decoding comprises decoding the data blocks using a second logic function that is a logical inverse of the first logic function.

24. The method of claim 23, wherein the encoding and decoding is performed on a block-by-block basis.

25. The method of claim 24, wherein the predetermined size is a byte or a word.

26. The method of claim 16, wherein the decoding comprises decoding only the respective output of the master device at the at least one slave device.
